(19) United States
(12) Patent Application Publication
(10) Pub. No.: US 2001/0051911 A1
(43) Pub. Date: Dec. 13, 2001

(54) Bidding method for internet/wireless advertising and priority ranking in search results

(76) Inventors: Michael B. Marks, South Orleans, MA (US); Joel Marks, Sherman Oaks, CA (US)

Correspondence Address: Brad I Golstein, Metro 88, 20755 Plummer Street, Chatsworth, CA, 91311, US

(21) Appl. No.: 09/852,809

(22) Filed: May 11, 2001

Related U.S. Application Data
(60) Provisional application No. 60/203,261, filed on May 9, 2000.

(51) Int. Cl. G06F 17/60

(52) U.S. Cl. 705/37; 705/14

(57) ABSTRACT

The present invention concerns a bidding method used to prioritize advertising and search result listings delivered to users of the Internet and Internet related devices and services. Listing entities such as advertisers bid on lower level target points (key words) at a list service provider. The list service provider defines a set of upper level target points available for correlation to the lower level target points that are the subject of the listing entity's bid. The target points when combined with a value of a bid comprise a handle. When correlated to upper level target points, the value of the combined handles of the lower level target points form the value for the handles of the upper level target points. In this manner, the present invention creates additional meaning and context to a given bid. A listing entity need not discover or select every term that may be useful—the list service provider performs all or some of this correlating service. The listing entity is enabled to leverage the value of bids by passively bidding on further correlated target points.

### FIELD OF THE INVENTION

The present invention concerns a bidding method used to prioritize advertising and search result listings delivered to users of the Internet and Internet related devices and services.

### BACKGROUND OF THE INVENTION

Advertising supports most Internet directory services and many entertainment and information sites. Examples of advertising supported directory services include GoTo.com and Yahoo.com.

In addition to receiving income from sales of banner ads and derivatives, GoTo.com receives income by charging for priority ranking in response to key word searches on a pay-per-click basis. Pay-per-click introduces a method for organizing sponsored listings. Other methodologies are used for listings that have not been sponsored. When a user performs a key word search at the GoTo.com web site, the initial ranking of results is determined by an amount pledged by the listing entity with respect to the given key word. If a user clicks on the entity's listing, the entity pays GoTo.com a specified amount. The more the entity pledges to pay for a click derived from a search of a given key word, the higher its listing will rank in GoTo.com's search results for that given key word. The cost per click is disclosed to the user in conjunction with the entity's listing. The advertiser must “buy” each key word for which it would like priority ranking in search results—buying the key word “hotels” does not confer value on more general key words such as “travel” or “vacations”.

Unlike GoTo.com, Yahoo.com utilizes human editors in conjunction with computer algorithms to organize and prioritize listings for pre-determined categories. Yahoo's method incorporates cross-referencing. General key word searches produce top-level category listings. Users are required to climb down a tree step by step to find the specific information they want.

Higher value advertising may support higher value goods and services. A user may therefore have an interest in receiving higher value advertising. U.S. Pat. No. 5,974,398, Hanson et al., discloses a bidding method wherein an advertiser bids a dollar amount that is paid to the user in return for receipt of the user's attention; the amount the advertiser has bid is disclosed to the user. When a user selects a given bid an advertising message is communicated to the user and the user earns the amount bid by the advertiser. In rewarding a user for his attention Hanson's method is similar to that disclosed by U.S. Pat. No. 5,794,210, Goldhaber, et al.

Listings and advertising may also be correlated to a user's location. Go2online.com and affiliated Go2-branded web sites are sources for geographically oriented search results and can correlate results to a location specified by the user. Listing entities can pay for priority ranking.

Another method for correlating advertising and search results to a user's location is disclosed in U.S. patent application Ser. No. 09/703,636 by Marks et al. The method disclosed by Marks et al. correlates advertising messages to the geographic location of a wireless transceiver on a cellular network in conjunction with a bidding system. The Lucent Wireless Data Gateway is method for locating a user device within a cell zone on a wireless network and may be used for targeting advertising messages and search result listings.

In wireless environments, whether information is supplied graphically to a screen of a hand held device or audibly through a speaker, the need for prioritized search results is particularly acute.

### SUMMARY

The present invention provides a system for prioritizing the presentation of one listing relative to another listing by comparing an amount bid on a descriptive handle that is attached to each listing. The value of the descriptive handle determines the level of priority accorded to the listing.

A descriptive handle is comprised of one or more key words or other descriptive attributes collectively known as target points and a bid amount: a handle is a target point and a corresponding bid. Target points are organized in the manner of a pyramid—specific target points at the bottom of the pyramid feed into more general target points toward the top. A bid for a target point at the bottom of the pyramid is a first handle and automatically generates a bid for a more general target point above it—this becomes a second handle for the same listing.

An entity may enter bids (create multiple first handles) for multiple target points for the same listing message. When bids from multiple target points for a single message are forwarded to the same upper level target point, the values of the first handle bids are combined in a second handle, Comprising the upper level target point and the combined amount of the bids. The value assigned to the second handle is for comparison to other such second handles.

The present invention may be used in preparing lists of search results or in maximizing the value of advertising delivered to a portable wireless device in a defined geographic area.

### BRIEF DESCRIPTION OF THE DRAWINGS

FIG. 1 shows a schematic search and display as seen by a user.

FIG. 2A is a generic pyramid of target points.

FIG. 2B is an exemplary pyramid of a target point bid.

FIG. 2C shows a geographic zone dependant pyramid of target points.

### DETAILED DISCLOSURE

The present invention comprises a list provider embodied as a node on the Internet linked to other nodes comprising listing entities, users and content and service providers. The list provider may further be connected to a wireless cellular data network. A listing entity may comprise an advertiser, business, group, association or individual seeking to deliver a text and/or graphics message to a user.

Using the present invention to target a listing, the listing entity accesses the site of the list provider. At the provider site the entity is presented with a form on which it may enter targeting information. Targeting information may comprise one or more of the following elements: 1) attributes describing a user's profile such as age, gender and income; 2) key words that a user might enter when conducting a search for listings; 3) information identifying a geographic zone or set of zones; 4) a time period. Collectively, such targeting information is called target points.

Information for correlating target points to a given set of users may be provided by the list provider itself or obtained from one or more third parties.

Differing target points correspond to different audience sizes and/or demographics. In the preferred embodiment the list provider enables the listing entity to know detailed information (historical and projected) about the audience corresponding to a given set of target points. For example, a target point sought by a listing entity may be a key word; the list provider may search its records to find the number of times the given key word was used in the past week.

In the preferred embodiment, the list provider establishes a minimum bid (or price) for each target point.

According to the invention a listing entity may browse hypothetical results before bidding. The results may show the popularity/frequency of target points. The results may further show a priority in ranking that would occur if a given bid were made.

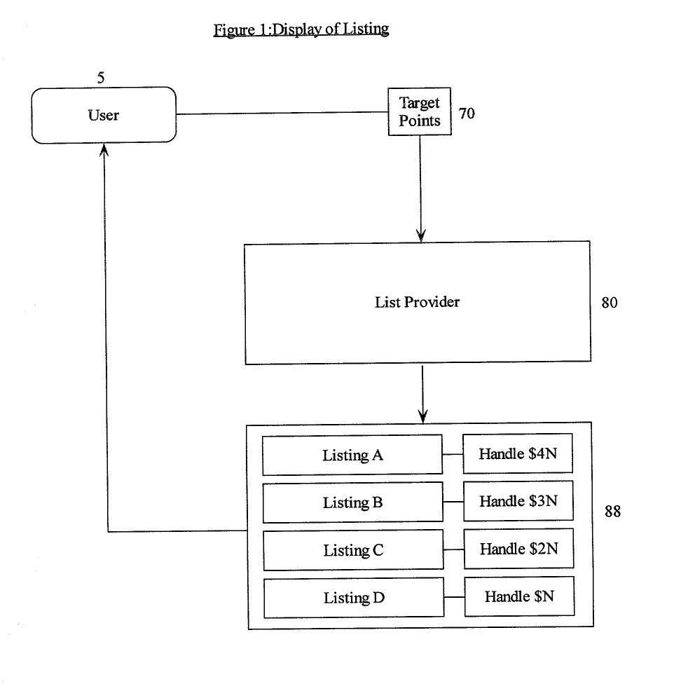

As shown in FIG. 1, user 5 performs a search by entering one or more target points 70 with list provider 80. Target points 70 comprises key words or other identifiable data that may be utilized in a search, including a specified geographic zone (a specified geographic zone may be entered by user 5 or may be detected from information emanating from the user's device or from a network operator affiliated with the device). Search results 88 are returned to user 5 organized such that the first listing corresponds to the highest value handle, the second listing to the second highest value handle and so on. Search results 88 may include listings without handles, listings for which bids have not been entered.

The list provider may limit the bidding process to a first time period. The bids may take effect in a subsequent and second time period. In this manner listing entities may compete for priority status in the first period while being protected in the second. The listing may therefore have a predetermined expiration time. The time period may be defined as a total number of views of search results for the given target point. Time period may also correspond to a temporal unit, for example, one month.

When listing entities bid for the same target point, the highest bid is accorded priority status. In a presentation of search results to a user, the listing correlated to the highest bid appears first, ahead of the other listings. The second highest bid correlates to the second listing and so on. Listing A has four times the value of listing D and therefore appears above listing D.

A target point pulls an attached listing from a database when a user either directly or indirectly causes a correlation in a search session to occur. A bid on the target point enables its attached listing to be ranked, by bid value, against other listings attached to the same target point.

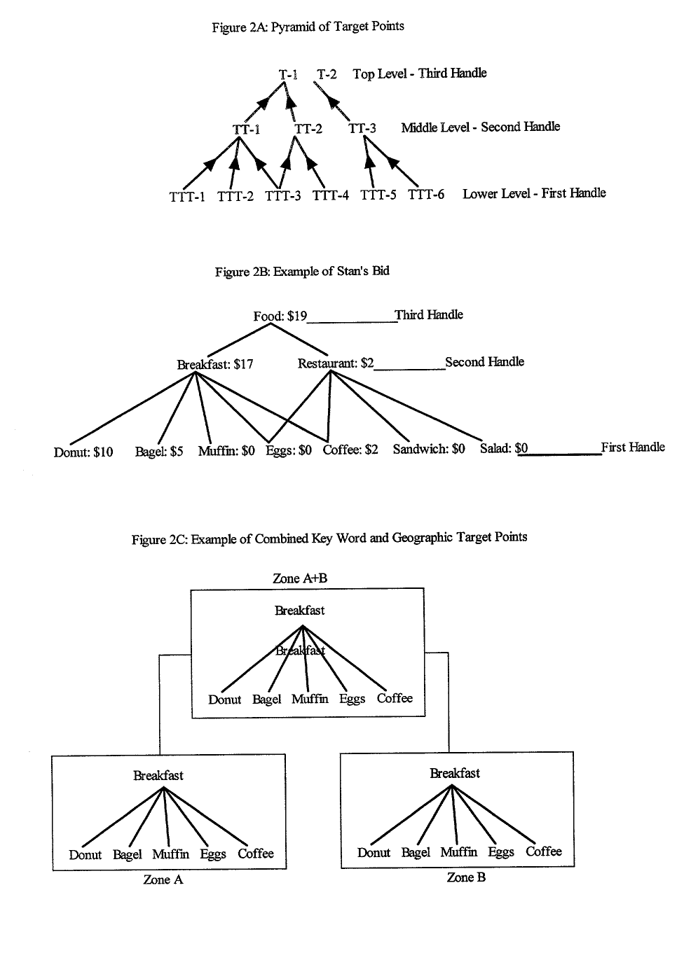

As shown in FIGS. 2A-2C, target points are organized in the manner of a pyramid—specific target points at the bottom of the pyramid feed into more general target points toward the top. A bid for a target point at the bottom of the pyramid is a first handle and automatically generates a value for a second handle attached to a more general target point above it. In turn the value for the second handle may generate a value for a third handle above it. The list provider determines the number of handle levels. An entity may enter bids on multiple lower level target points for the same message and thereby create multiple, unique, first handles. When these lower level target points correspond to the same upper level target point, the bids are combined in the same second level handle—the value of the second handle is thus the total of the first handle bids it contains. Search result listings for upper level target points are prioritized in the same manner as lower level search listings—higher value handles receive priority. The value assigned to the second handle is for comparison purposes and does not constitute a specific cost to the listing entity.

The listing entity is charged only for the bids on lowest level target points—those corresponding to first handles. The charge is a fee for a given time period. A company bidding $1 on ten lower level target points for a single listing creates 10 first handles valued at $1 each. The fee for the time period is $10. If all ten lower level target points (first handles) feed into the same upper level target point, a second handle valued at $10 is created for the upper level target point. The creation and valuation of the second handle does not affect the fee. It is possible that the ten lower level target points may feed two or more upper level target points; in such case two or more second handles will be created and valued accordingly.

Either the list service provider or the listing entity may determine the upper level target points available for correlation with particular lower level target points. According to one example, the list provider selects the upper level target points and the listing entity decides which of those target points to use for respective correlations. The list provider may determine how many upper level correlations are allowed for each lower level target point. It may be desired that each lower level target point correlates to exactly one upper level target point. The list provider may allow additional correlations with each listing purchase. For example, one lower level target point may be allowed to correlate to two upper level target points.

For example, the list provider may allow one correlation for each lower level target point. In a variation this 1 to 1 correlation of lower level to upper level target points may be modified with the addition of a set quantity of extra target point correlations.

The present invention may be used in conjunction with other factors to determine positioning or presentation characteristics.

Prominence of a listing may be expressed by use of a larger font size, graphics or distinctive sound rather than, or in addition to, list position.

Listing entities may wish to have priority in search results for a specified geographic zone. To do this a geographic zone must be available for specification as a target point and such target point must be combined with other target points. The specification of a geographic target point may be automatically enabled with information supplied by a wireless network (the location of the cell transceiver being used for access to the list provider may be known and utilized), with information from the user's device (GPS coordinates may be sent in the course of performing a search), or by user input.

Geographic target points may be automatically weighted by proximity to the user such that a bid for a target point comprising a specific zone is valued at 100% of its bid amount when a user is in the zone and less than 100% when the user is outside of the zone. As the user moves further away from geographic zone specified as a target point the more the bid value is reduced.

FIG. 2C shows an example of prioritization of search results with respect to specified geographic zones. Within both Zone A or Zone B a search may be performed and the results will be prioritized without consideration of the other zone. Each zone shows a group of lower level target points feeding into an upper level target point. Listing entities bid on lower level target points in either Zone A or Zone B—this bidding creates first and second handles applicable wholly within Zone A or Zone B. However, if a user performs a search for listings within both zones simultaneously the listings of the two zones are combined as if they comprised a single zone and prioritized accordingly.

An example application of the invention:

For a list of “donut stands, zone A” Andy's Donuts has paid $10 for the top listing and John's Donuts has paid nothing. These are the only donut stands in the zone; the list presents Andy's Donuts first and John's Donuts second. Meanwhile, Bill's Donuts has paid $20 for the top listing in Zone B, while Frank's Donuts and Hal's Donuts, also in Zone B paid nothing. Judy driving in a car in Zone A searches for “closest donuts” and receives Andy's listing first, followed by John's. Unsatisfied with the search results she next searches for “donuts in Zones A and B.” Now she receives listings ordered (and paid for/sorted) as follows: Bill's ($20), Andy's ($10), John's (handicapped for Zone A proximity), then Frank's followed by Hal's (ordered alphabetically).

If Judy performs a search for “breakfast in Zones A and B” she may receive listings for fast food, grocery stores and coffee houses along with the listings for donut stands. In this broader category the listings are again first ordered by amounts paid for listings, followed by ordering by means of other fixed matrices. If the amount paid for a listing by Bill's Donuts is higher than amounts paid by fast food purveyors, grocery stores, etc., then the entry for Bill's Donuts will be delivered to Judy first when she inquires after “breakfast in Zones A and B”.

As Judy widens her search, whether by adding zones further away from her location or by searching ever-broader categories, it becomes increasingly unlikely that Bill's Donuts will maintain its top listing position in the delivered search results. Inquiring after “food in Zones A-Z”, Judy will likely find the listing for Bill's Donuts many places behind listings for restaurants, grocery stores and gourmet shops that are located many zones away.

“Donuts” comprises a lower level key word; likewise, the words “bagels” and “coffee” comprise lower level key words. These three lower level words all correspond to the upper level word, “breakfast.” Using the method of the present invention, Stan's Bagels and Donuts bids $10 for “donuts”, $5 for “bagels” and $2 for “coffee”. These bids on key words correspond to first level handles on the target points “donuts”, “bagels” and “coffee.” As shown in FIG. 2B all three of Stan's bids are automatically forwarded to a second handle for the upper level target point “breakfast”. Stan's second handle for “breakfast” has a value of $17. Stan's bid on “coffee” is automatically forwarded to a second handle for “restaurant”. Stan's second handle for “restaurant” has a value of $2. Lower level bids are automatically correlated to upper levels. The $17 second handle for “breakfast” and the $2 second handle for “restaurant” are automatically transferred to a third handle for “food” wherein the third handle has a value of $19.

A user searching for “food” will thus find Stan's listing prioritized by a $19 handle. Likewise a $17 handle prioritizes Stan's listing if the search is for “breakfast”, a $2 handle if the search is for “restaurant” and a $10 handle if the search is for “donut”.

When a user performs a search using multiple key words, the values contained in the handles for each of the words are combined to form a higher-level handle value for the given combination of multiple key words. The resulting list of search results is prioritized with respect to this higher-level handle value. For example, in response to a search for “donuts and coffee”, the listing for Stan's will have a third handle valued at $12 ($10 for “donuts” +$2 for “coffee”). And in response to a search for “breakfast donuts” the listing for Stan's will have a third handle valued at $27 ($17 for “breakfast” and $10 for “donuts”).

Rather than entering a high bid for a single upper level listing, businesses have an incentive to bid on multiple lower lever key words. In this manner a business effectively performs a self-evaluation and bids highest on key words that correspond to its particular strengths.

The geographically oriented bidding method of the present invention may be applied to all types of businesses, services, offerings and events. In some applications, such as real estate, the system may limit its search to within the given category so that dissonance from irrelevant search results is eliminated.

When operating within a given category an alternate embodiment may be desired. In this embodiment the value for a second handle corresponding to a top level target point is fixed and listing entities are instructed to create first handles for lower level target points such that the combined value for all of the first handles equals the pre-determined second handle value. This arrangement is the reverse of that described above; here the second handle defines a value of the upper level target point. First handles are correlated to fit the values the second handles. This could enhance the comparative capabilities of the system as shown in the examples below.

Following is an example of values to first handles corresponding to lower level target points for a real estate listing; the combined value for the first handles equals a predetermined second handle value.

Home Listing Form: Home Price range $400,000-$500,000, Geographic Zone “X” Instructions to Realtor (listing entity):

Below are listed a series of key words describing various features typical of homes in Zone “X”. Place bids on the features that differentiate this home from other homes. Bid on all of the features which apply. If a home does not have the feature the bid should be zero. The total of the bids must equal $40. You may also place a bid on “Quality Throughout” to indicate excellence in all of the features and automatically allocate an equal amount to each feature.

| Living Room | $_{———} |
|---|---|
| Dining Room | $_{———} |
| Kitchen | $_{———} |
| Bathrooms | $_{———} |
| Master Bedroom | $_{———} |
| Guest Room | $_{———} |
| Garden | $_{———} |
| Schools | $_{———} |
| Pool | $_{———} |
| View | $_{———} |
| Quality Throughout | $_{———} |
| TOTAL | $40 |

Following is an example of entries on the listing form for homes A, B and C using the method above:

| KEY WORDS | Home A | Home B | Home C |
|---|---|---|---|
| Living Room | 5 | 4 | 10 |
| Dining Room | 5 | 4 | 0 |
| Kitchen | 10 | 4 | 10 |
| Bathrooms | 2 | 4 | 2 |
| Master Bedroom | 0 | 4 | 0 |
| Guest Room | 0 | 4 | 0 |
| Garden | 3 | 4 | 0 |
| Schools | 0 | 4 | 0 |
| Pool | 5 | 4 | 3 |
| View | 10 | 4 | 15 |
| Quality Throughout | — | Select | — |
| TOTAL | 40 | 40 | 40 |

There is no limitation on the number of key words that may be used. The method for selecting a fixed bid amount may be determined with regard to alternative advertising and listing opportunities.

Home A's first handle value for View is $10, Home B's is $4 and Home C's is $15. Home A's first handle value for Pool is $5, Home B's is $4 and Home C's is $3. To perform a search of home listings a user is instructed to enter key words that correspond to those used on the listing form. Combining multiple key words causes the values of the associated first handles to be combined in a third handle that organizes the listings by third handle values.

Thus, a search for “View, Pool” creates a list as follows:

Home C ($18)

Home A ($15)

Home B ($8)

Continuing the example, if a user enters the terms “Living Room, Dining Room, Kitchen, Master Bedroom, Schools” the list would be presented as follows:

Home A ($20), Home B ($20), Home C ($20)=tie.

In the event of a tie an additional method is used for organizing results to enable presentation in a vertical list format. The method may be date of entry onto the list, most recent listings first followed by older listings or vice versa. Another method for organizing tied results is to give priority to those listings most proximate to the user performing the search.

This method of the invention may be used in conjunction with multiple listings services.

The embodiment described above could be applied to classified and bulletin board listings of items for sale and events: cars, computers, concerts, yard sales and wine tastings. Searches may be performed for a particular zone or for multiple zones. In any search, the listing with the highest value handle receives priority listing followed by the listing with the next highest value handle.

Handles automatically expire at the end of their given time period. The value of a target point bid drops to zero unless renewed. Listings with zero value handles may be dropped from the list entirely or relegated to lower level status, appearing after listings with handles of minimum or greater value.

1. A system for assigning value to listings correlated to user queries wherein:
a lower level target point describes information that may be used in a query;
a listing entity bids on the lower level target point, the bid defining a value of the lower level target point, the lower level target point combined with the bid forming a lower level handle;
an upper level target point comprises information that may be used in a query;
an upper level handle being a combination of a value of the upper level target point with the information of the upper level target point;
the information of the upper level handle being correlated to the information of at least one lower level handle;
the value of the lower level handle being a component of the value of the upper level handle;
the listing entity selects particular information comprising a listing that is presented to a user in response to a query from the user, the listing being correlated to both the upper and the lower level handles;
other listings corresponding to other handles;
the user being presented the listing in conjunction with the other listings wherein a listing with a higher value handle is accorded priority over a listing with a lower value handle.

2. The system of claim 1 wherein the handles of the other listings and a handle of the listing incorporate a same target point.

3. The system of claim 1 wherein the listing entity places a bid on each of multiple target points for the listing thereby creating multiple lower level handles and the values and information of at least two or more lower level handles are correlated to at least one upper level handle.

4. The system of claim 2 wherein the same target point describes geographic information.

5. The system of claim 3 wherein the listing and other listings are hosted by a list provider embodied as a node on the Internet, the user accesses the list provider by means of a wireless network and the list provider presents the listing and other listings to the user audibly as voice information.

6. The system of claim 1 wherein other handles are hosted by a list provider;
a lower level handle is tentatively created by the listing entity;
the list provider compares the lower level handle to the other handles;
the list provider shows the comparison to the listing entity.

7. A system of payment for the presentation of a message to user where a listing entity desires to have the message assigned a level of priority by a list service provider when the user searches for information that is relevant to the listing entity wherein:
the message is associated with at least one descriptive target point;
the list service provider organizes a plurality of target points in the manner of a pyramid such that a plurality of specific lower target points at a bottom of the pyramid feed into more general upper target points toward a top of the pyramid;
the listing entity bids a value for a first lower target point and the list service provider automatically correlates the first lower target point to an upper target point;
the listing entity bids a value for a second lower target point, the second lower target point being corresponded to the same upper target point, and the value of the upper target point increases by the value of the bid on the second lower target point, the listing entity thereby passively bidding a value on the upper target point when the list service provider combines the bids for the first and second lower target points to create the value of the upper target point;
the level of priority for presentation of the message to the user is determined by the value of a target point bid, where the target point matches a description of the user's search.

8. The system of payment of claim 7 wherein one of the first and second lower target points matches a description of the user's search, and the message is assigned a lower level of priority.

9. The system of payment of claim 7 wherein the upper target point matches a description of the user's search, and the message is assigned an upper level of priority, the upper level of priority being more prominent than a lower level of priority that corresponds to a search description matching one of the lower target points.

10. The system of claim 7 wherein a target point describes geographic information.

11. The system of claim 7 wherein the message is hosted by a list provider embodied as a node on the Internet, the user accesses the list provider by means of a wireless network and the list provider presents the message to the user audibly as voice information.

12. The system of claim 7 wherein a target point has previously received a bid from a further listing entity and; the target point is tentatively bid upon by the listing entity; the list provider compares the bid from the listing entity with the bid from the further listing entity; the list provider shows the comparison to the listing entity.

13. A system for presenting listings to a user performing a search of listings comprising;
an upper level target point of a fixed bid value;
a listing corresponding to the upper level target point and to a plurality of pre-determined lower level target points;
the lower level target points corresponding to the upper level target point wherein each lower level target point incorporates a variable bid value and a total value of all of the variable bids for the respective lower level target points equals the fixed bid value of the upper level target point.

14. The system of claim 13 wherein a listing entity has entered a first listing and a second listing corresponding to the same upper level target point with a list provider;
the first listing associated with at least one lower level target point and a bid value;
the second listing associated with at least one lower level target point and a bid value;
a user performing a search that specifies at least one lower level target point.

15. The system of claim 14 wherein the bid value associated with a lower level target point of the first listing is less than the bid value associated with a lower level target point of the second listing;
the lower level target point of the first listing and the lower level target point of the second listing comprising a same target point;
the user search specifying the same target point;
the list provider presenting the first and second listings to the user such that the second listing is accorded priority over the first listing.

16. The system of claim 15 wherein the listing entity for the first listing and the listing entity for the second listing are independent.

17. The system of claim 15 wherein a listing comprises a unit of real estate.

18. The listing of claim 17 wherein the upper level target point comprises a price and a geographic area.
